(19) United States
(12) Patent Application Publication
(10) Pub. No.: US 2023/0020679 A1
(43) Pub. Date: Jan. 19, 2023

(54) POWER STORAGE DEVICE

(71) Applicant: TOYOTA JIDOSHA KABUSHIKI KAISHA, Toyota-shi Aichi-Ken (JP)

(72) Inventor: Shinya Goitsuka, Nisshin-shi Aichi-ken (JP)

(73) Assignee: TOYOTA JIDOSHA KABUSHIKI KAISHA, Toyota-shi Aichi-Ken (JP)

(21) Appl. No.: 17/861,439

(22) Filed: Jul. 11, 2022

(30) Foreign Application Priority Data
Jul. 13, 2021 (JP) 2021-115673

(51) Int. Cl. H01M 50/244; H01M 50/209

(52) U.S. Cl. CPC H01M 50/244; H01M 50/209; H01M 50/249

(57) ABSTRACT

A power storage device includes: a first power storage module; a second power storage module; a case; a first attachment member that serves to couple one end portion of the first power storage module and one end portion of the second power storage module to each other, and to attach the one end portions to the case; and a second attachment member that serves to couple the other end portion of the first power storage module and the other end portion of the second power storage module to each other, and to attach the other end portions to the case. The second attachment member is lower in flexural rigidity than the first attachment member.

This nonprovisional application is based on Japanese Patent Application No. 2021-115673 filed on Jul. 13, 2021 with the Japan Patent Office, the entire contents of which are hereby incorporated by reference.

### BACKGROUND

### Field

The present disclosure relates to a power storage device.

### Description of the Background Art

Conventionally, a power storage device mounted on a vehicle or the like has been known. For example, Japanese Patent Laying-Open No. 2019-133866 discloses a vehicle mount structure for battery modules, the vehicle mount structure including: a plurality of battery modules; and a plurality of attachment members for attaching each of the plurality of battery modules to a side frame. The plurality of battery modules are arranged side by side in a direction orthogonal to a longitudinal direction of each battery module.

### SUMMARY

In the mount structure for power storage modules as disclosed in Japanese Patent Laying-Open No. 2019-133866, in order to enhance the mounting efficiency for a vehicle, it is conceivable to increase the number of power storage cells included in each of the power storage modules, and to mount two adjacent power storage modules on a vehicle in the state in which these power storage modules are integrated by a dedicated coupling member. This however causes a concern that the dedicated member may be damaged due to the thickness tolerance of each power storage cell, or expansion and contraction of each power storage cell.

An object of the present disclosure is to provide a power storage device capable of suppressing damage to a member that couples two power storage modules to each other while enhancing the efficiency of mounting each power storage module on a vehicle.

A power storage device according to an aspect of the present disclosure includes: a first power storage module having a shape elongated in one direction; a second power storage module having a shape elongated in the one direction and located to be adjacent to the first power storage module in an orthogonal direction orthogonal to both the one direction and an upward/downward direction; a case that accommodates the first power storage module and the second power storage module; a first attachment member that serves to couple one end portion of the first power storage module in the one direction and one end portion of the second power storage module in the one direction to each other, and to attach the one end portion of the first power storage module and the one end portion of the second power storage module to the case; and a second attachment member that serves to couple the other end portion of the first power storage module in the one direction and the other end portion of the second power storage module in the one direction to each other, and to attach the other end portion of the first power storage module and the other end portion of the second power storage module to the case, the first power storage module and the second power storage module each include a plurality of power storage cells arranged side by side in the one direction, and the second attachment member is lower in flexural rigidity than the first attachment member.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing a configuration of a power storage device according to one embodiment of the present disclosure.

FIG. 2 is an enlarged view of a portion indicated by a solid line II in FIG. 1.

FIG. 3 is an enlarged perspective view of a second attachment member.

FIG. 4 is an exploded perspective view of the second attachment member.

### DESCRIPTION OF THE EMBODIMENTS

Embodiments of the present disclosure will be hereinafter described with reference to the accompanying drawings, in which the same or corresponding members are denoted by the same reference numerals.

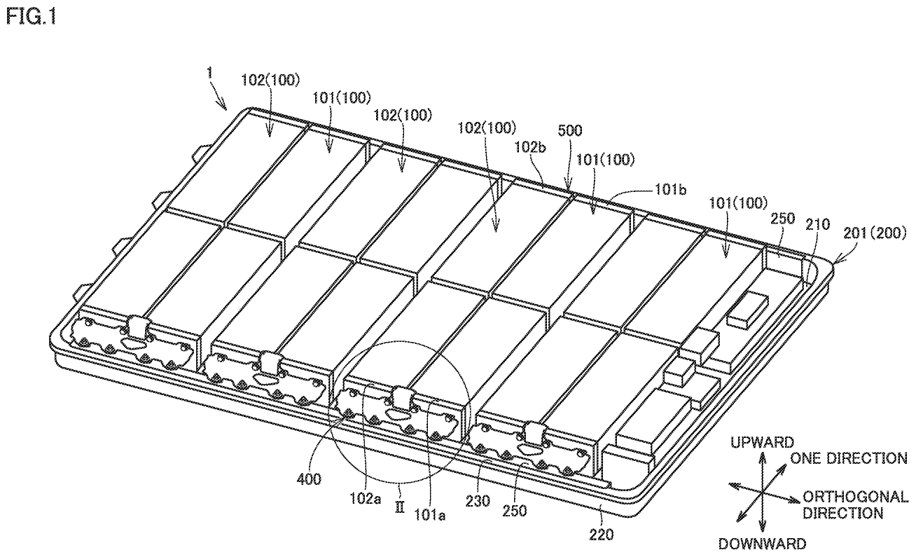

FIG. 1 is a perspective view schematically showing a configuration of a power storage device according to one embodiment of the present disclosure. A power storage device 1 is mounted on a vehicle, for example.

As shown in FIGS. 1 to 4, power storage device 1 includes a plurality of power storage modules 100, a case 200, a monitoring unit 300, a first attachment member 400, and a second attachment member 500.

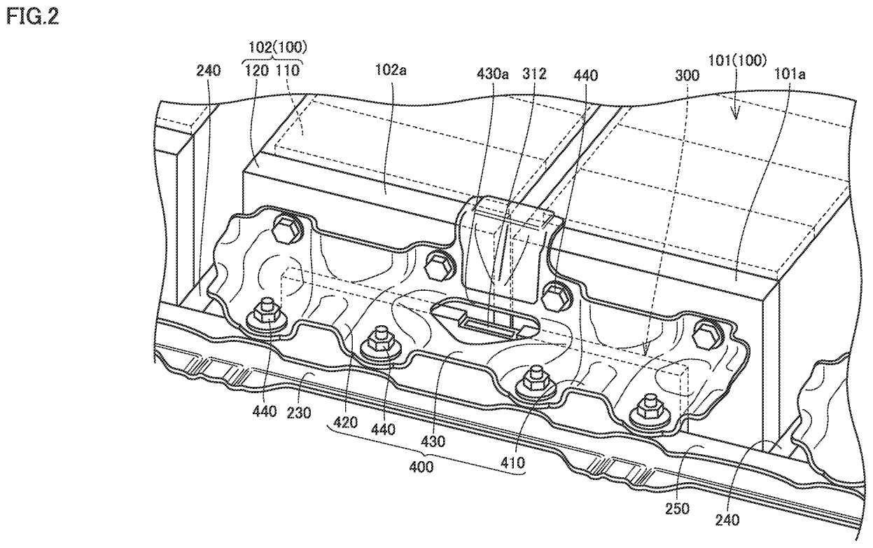

The plurality of power storage modules 100 each include a first power storage module 101 and a second power storage module 102 that are adjacent to each other. As shown in FIG. 2, each power storage module 100 includes a plurality of power storage cells 110 and a pair of end plates 120.

The plurality of power storage cells 110 are arranged side by side in one direction. Examples of power storage cell 110 include a lithium ion battery. Each power storage cell 110 is formed in a rectangular parallelepiped shape. As shown in FIG. 1, the plurality of power storage modules 100 each including first power storage module 101 and second power storage module 102 are arranged side by side in an orthogonal direction orthogonal to both the above-mentioned one direction and an upward/downward direction.

The pair of end plates 120 are disposed on both sides of the plurality of power storage cells 110 in the one direction. Each end plate 120 is made of metal (aluminum or the like).

Case 200 accommodates the plurality of power storage modules 100. Case 200 includes a lower case 201 and an upper case (not shown).

Lower case 201 is shaped to open upward. Lower case 201 is made of metal. Lower case 201 includes a bottom wall 210, a circumferential wall 220, a flange 230, a partition wall 240, and a reinforcing bracket 250.

Bottom wall 210 is disposed below the plurality of power storage modules 100. A cooler (not shown) may be provided below bottom wall 210, and a thermally conductive layer (not shown) may be provided between bottom wall 210 and the cooler and between bottom wall 210 and power storage module 100.

Circumferential wall 220 is provided upright from the circumferential edge of bottom wall 210 and surrounds the plurality of power storage modules 100.

Flange 230 is shaped to protrude outward from an upper end portion of circumferential wall 220.

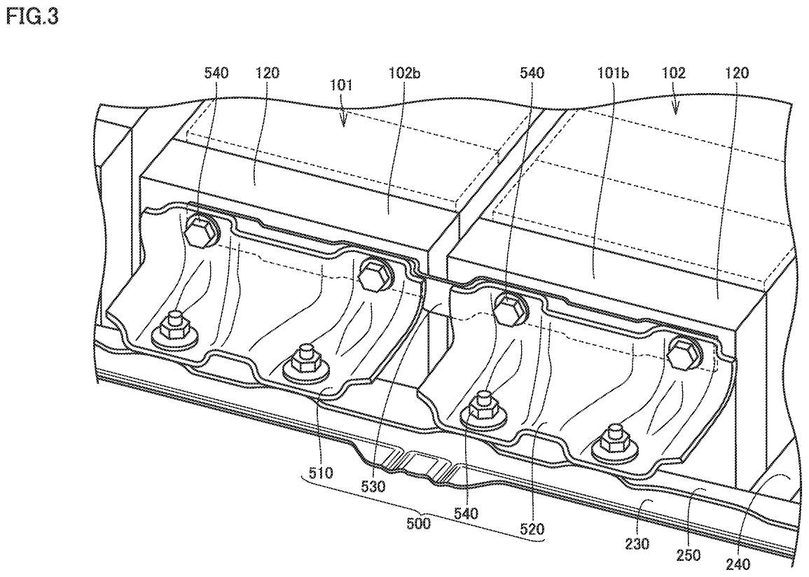

As shown in FIGS. 2 and 3, partition wall 240 provides a partition between a pair of power storage modules 100 adjacent to each other in the orthogonal direction. Both ends of partition wall 240 in the one direction are connected to circumferential wall 220. In other words, partition wall 240 has a function of reinforcing circumferential wall 220.

Reinforcing bracket 250 is disposed between circumferential wall 220 and power storage module 100 in the one direction. Reinforcing bracket 250 reinforces the attachment of power storage module 100 to bottom wall 210. A lower end portion of reinforcing bracket 250 is fixed to bottom wall 210 by welding or the like, and an upper end portion of reinforcing bracket 250 is fixed to flange 230 by welding or the like.

The upper case is shaped to open downward. Together with lower case 201, the upper case accommodates the plurality of power storage modules 100. The upper case is made of metal.

Monitoring unit 300 monitors the plurality of power storage modules 100. Monitoring unit 300 is disposed inside case 200. As shown in FIG. 2, monitoring unit 300 is disposed between power storage module 100 and circumferential wall 220 in the one direction. Monitoring unit 300 includes a substrate on which elements for monitoring the voltage, the temperature, and the like of each power storage cell 110 are mounted. As shown in FIG. 2, a connector 312 is provided above the substrate.

As shown in FIG. 2, first attachment member 400 serves to couple one end portion 101a of first power storage module 101 in the one direction and one end portion 102a of second power storage module 102 in the one direction to each other, and to attach one end portion 101a of first power storage module 101 and one end portion 102a of second power storage module 102 to case 200. In the present embodiment, one end portion 101a of first power storage module 101 and one end portion 102a of second power storage module 102 each are formed of end plate 120. First attachment member 400 is made of metal. First attachment member 400 covers the upper side of monitoring unit 300.

First attachment member 400 includes a first attachment portion 410, a second attachment portion 420, a coupling portion 430, and a plurality of first fastening members 440.

First attachment portion 410 serves to attach one end portion 101a of first power storage module 101 to case 200. First attachment portion 410 is fixed to one end portion 101a and case 200 by first fastening member 440. Specifically, an inner end portion of first attachment portion 410 in the one direction is fixed to one end portion 101a, and an outer end portion of first attachment portion 410 in the one direction is fixed to the upper end portion of reinforcing bracket 250.

Second attachment portion 420 serves to attach one end portion 102a of second power storage module 102 to case 200. Second attachment portion 420 is fixed to one end portion 102a and case 200 by first fastening member 440. Specifically, an inner end portion of second attachment portion 420 in the one direction is fixed to one end portion 102a, and an outer end portion of second attachment portion 420 in the one direction is fixed to the upper end portion of reinforcing bracket 250.

Coupling portion 430 couples first attachment portion 410 and second attachment portion 420 to each other. Coupling portion 430 is formed between first power storage module 101 and second power storage module 102 in the orthogonal direction. Coupling portion 430 is provided with an opening 430a through which connector 312 is exposed.

As shown in FIG. 3, second attachment member 500 serves to couple the other end portion 101b of first power storage module 101 in the one direction and the other end portion 102b of second power storage module 102 in the one direction to each other, and to attach the other end portion 101b of first power storage module 101 and the other end portion 102b of second power storage module 102 to case 200. In the present embodiment, the other end portion 101b of first power storage module 101 and the other end portion 102b of second power storage module 102 each are formed of end plate 120. Second attachment member 500 is lower in flexural rigidity than first attachment member 400.

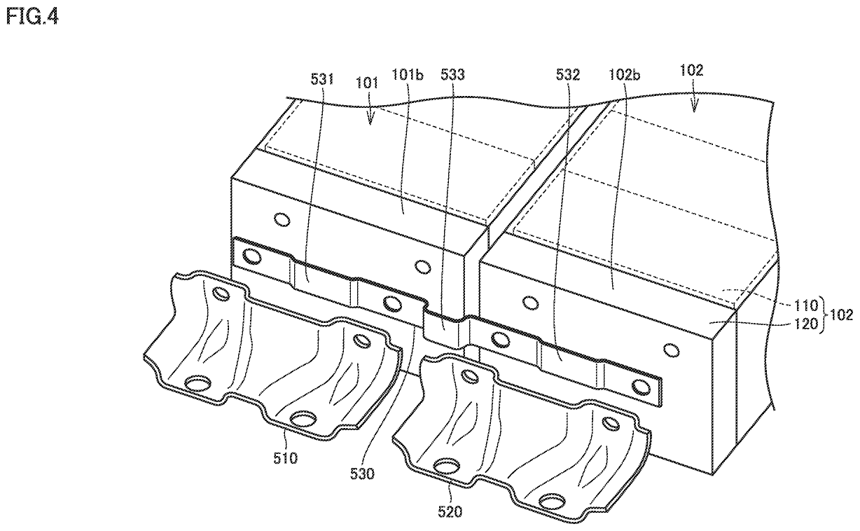

The “flexural rigidity” means the rigidity acting when attachment members 400 and 500 are bent in a plane orthogonal to the upward/downward direction. For example, the flexural rigidity of second attachment member 500 means the rigidity acting when the other end portion 102b of second power storage module 102 moves in the one direction relative to the other end portion 101b of first power storage module 101 or when one end portion 102a of second power storage module 102 moves in the orthogonal direction relative to one end portion 101a of first power storage module 101. As shown in FIGS. 3 and 4, second attachment member 500 includes a first bracket 510, a second bracket 520, a coupling bracket 530, and a second fastening member 540.

First bracket 510 serves to attach the other end portion 101b of first power storage module 101 to case 200. First bracket 510 is fixed to the other end portion 101b and case 200 by second fastening member 540. Specifically, an inner end portion of first bracket 510 in the one direction is fixed to the other end portion 101b, and an outer end portion of first bracket 510 in the one direction is fixed to the upper end portion of reinforcing bracket 250. First bracket 510 is made of metal.

Second bracket 520 serves to attach the other end portion 102b of second power storage module 102 to case 200. Second bracket 520 is fixed to the other end portion 102b and case 200 by second fastening member 540. Specifically, an inner end portion of second bracket 520 in the one direction is fixed to the other end portion 102b, and an outer end portion of second bracket 520 in the one direction is fixed to the upper end portion of reinforcing bracket 250. Second bracket 520 is made of metal.

Coupling bracket 530 serves to couple the other end portion 101b of first power storage module 101 and the other end portion 102b of second power storage module 102 to each other. Coupling bracket 530 is lower in flexural rigidity than first attachment member 400.

As shown in FIG. 4, coupling bracket 530 includes a first connecting portion 531, a second connecting portion 532, and a low-rigidity portion 533.

First connecting portion 531 is connected to the other end portion 101b of first power storage module 101. First connecting portion 531 is fixed to the other end portion 101b (end plate 120) of first power storage module 101 by second fastening member 540. In the present embodiment, first bracket 510 and first connecting portion 531 are fixed to the other end portion 101b by common second fastening member 540.

Second connecting portion 532 is connected to the other end portion 102b of second power storage module 102. Second connecting portion 532 is fixed to the other end portion 102b (end plate 120) of second power storage module 102 by second fastening member 540. In the present embodiment, second bracket 520 and second connecting portion 532 are fixed to the other end portion 102b by common second fastening member 540.

Low-rigidity portion 533 is formed between first connecting portion 531 and second connecting portion 532. Low-rigidity portion 533 is lower in flexural rigidity than first attachment member 400. Low-rigidity portion 533 is smaller in thickness than first attachment member 400. Low-rigidity portion 533 is smaller in thickness than each of first bracket 510 and second bracket 520. As shown in FIG. 4, low-rigidity portion 533 is shaped to protrude outward in the one direction with respect to first connecting portion 531 and second connecting portion 532.

The length of low-rigidity portion 533 in the upward/downward direction is the same as that of first connecting portion 531 and that of second connecting portion 532 in the upward/downward direction. However, the length of low-rigidity portion 533 in the upward/downward direction may be different from that of first connecting portion 531 and that of second connecting portion 532 in the upward/downward direction.

As shown in FIG. 3, the length of low-rigidity portion 533 in the orthogonal direction is greater than the distance between first bracket 510 and second bracket 520 in the orthogonal direction. Specifically, a boundary portion between first connecting portion 531 and low-rigidity portion 533 is in contact with end plate 120 of first power storage module 101, while a boundary portion between second connecting portion 532 and low-rigidity portion 533 is in contact with end plate 120 of second power storage module 102. A portion of low-rigidity portion 533 that faces a gap between first power storage module 101 and second power storage module 102 in the one direction is formed in a flat plate shape.

As described above, in power storage device 1 of the present embodiment, second attachment member 500 is lower in flexural rigidity than first attachment member 400, and therefore, the thickness tolerance of each power storage cell 110 and expansion and contraction of each power storage cell 110 are absorbed by deformation of second attachment member 500. This makes it possible to suppress damage to attachment members 400 and 500 that each couple two power storage modules 101 and 102 to each other, while enhancing the efficiency of mounting each power storage module on a vehicle.

In the above-described embodiment, first bracket 510, second bracket 520, and coupling bracket 530 may be formed as a one-piece member.

It will be appreciated by those skilled in the art that the above-described illustrative embodiments are specific examples of the following aspects.

A power storage device according to the above-described embodiment includes: a first power storage module having a shape elongated in one direction; a second power storage module having a shape elongated in the one direction and located to be adjacent to the first power storage module in an orthogonal direction orthogonal to both the one direction and an upward/downward direction; a case that accommodates the first power storage module and the second power storage module; a first attachment member that serves to couple one end portion of the first power storage module in the one direction and one end portion of the second power storage module in the one direction to each other, and to attach the one end portion of the first power storage module and the one end portion of the second power storage module to the case; and a second attachment member that serves to couple the other end portion of the first power storage module in the one direction and the other end portion of the second power storage module in the one direction to each other, and to attach the other end portion of the first power storage module and the other end portion of the second power storage module to the case, the first power storage module and the second power storage module each include a plurality of power storage cells arranged side by side in the one direction, and the second attachment member is lower in flexural rigidity than the first attachment member.

In the present power storage device, the second attachment member is lower in flexural rigidity than the first attachment member, and therefore, the thickness tolerance of each power storage cell and expansion and contraction of each power storage cell are absorbed by deformation of the second attachment member. This makes it possible to suppress damage to each attachment member that couples two power storage modules to each other, while enhancing the efficiency of mounting each power storage module on a vehicle.

In some embodiments, the second attachment member includes: a first bracket that serves to attach the other end portion of the first power storage module to the case; a second bracket that serves to attach the other end portion of the second power storage module to the case; and a coupling bracket that couples the other end portion of the first power storage module and the other end portion of the second power storage module to each other, and the coupling bracket is lower in flexural rigidity than the first attachment member.

In the above-described aspect, adjusting the flexural rigidity of the coupling bracket makes it possible to deal with, for example, the change in number of power storage cells included in each power storage module.

In some embodiments, the coupling bracket includes: a first connecting portion connected to the other end portion of the first power storage module; a second connecting portion connected to the other end portion of the second power storage module; and a low-rigidity portion that is formed between the first connecting portion and the second connecting portion, the low-rigidity portion being lower in flexural rigidity than the first attachment member.

In some embodiments, the low-rigidity portion is shaped to protrude outward in the one direction with respect to the first connecting portion and the second connecting portion.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage device comprising:
a first power storage module having a shape elongated in one direction;
a second power storage module having a shape elongated in the one direction and located to be adjacent to the first power storage module in an orthogonal direction orthogonal to both the one direction and an upward/downward direction;
a case that accommodates the first power storage module and the second power storage module;
a first attachment member that serves to couple one end portion of the first power storage module in the one direction and one end portion of the second power storage module in the one direction to each other, and to attach the one end portion of the first power storage module and the one end portion of the second power storage module to the case; and
a second attachment member that serves to couple the other end portion of the first power storage module in the one direction and the other end portion of the second power storage module in the one direction to each other, and to attach the other end portion of the first power storage module and the other end portion of the second power storage module to the case, wherein
the first power storage module and the second power storage module each include a plurality of power storage cells arranged side by side in the one direction, and
the second attachment member is lower in flexural rigidity than the first attachment member.

2. The power storage device according to claim 1, wherein
the second attachment member includes
a first bracket that serves to attach the other end portion of the first power storage module to the case,
a second bracket that serves to attach the other end portion of the second power storage module to the case, and
a coupling bracket that couples the other end portion of the first power storage module and the other end portion of the second power storage module to each other, and
the coupling bracket is lower in flexural rigidity than the first attachment member.

3. The power storage device according to claim 2, wherein
the coupling bracket includes
a first connecting portion connected to the other end portion of the first power storage module,
a second connecting portion connected to the other end portion of the second power storage module, and
a low-rigidity portion that is formed between the first connecting portion and the second connecting portion, the low-rigidity portion being lower in flexural rigidity than the first attachment member.

4. The power storage device according to claim 3, wherein the low-rigidity portion is shaped to protrude outward in the one direction with respect to the first connecting portion and the second connecting portion.
